(19) United States
(12) Patent Application Publication
(10) Pub. No.: US 2025/0265234 A1
(43) Pub. Date: Aug. 21, 2025

(54) MODIFYING DATA PIPELINE AND DATASET QUALITY USING DATA OBSERVABILITY

(71) Applicant: INTERNATIONAL BUSINESS MACHINES CORPORATION, Armonk, NY (US)

(72) Inventors: Rajmohan Chandrahasan, Kanchipuram District (IN); Nishtha Madaan, Gurgaon (IN); Himanshu Gupta, Vasant Kunj (IN); Sameep Mehta, Bangalore (IN)

(21) Appl. No.: 18/581,814

(22) Filed: Feb. 20, 2024

(51) Int. Cl. G06F 16/215; G06F 16/28

(52) U.S. Cl. CPC G06F 16/215; G06F 16/285

(57) ABSTRACT

A computer-implemented process for modifying one or more of a plurality of data pipelines within a computer architecture that processes data from a plurality of datasets includes the following operations. Real-time observability data regarding the plurality of data pipelines and the plurality of datasets is ingested. A dataset from the plurality of datasets is classified based upon usage and reliability to generate a classification of the dataset. Based upon the classification, a recommendation to modify at least one of the plurality of data pipelines or the quality of one of the plurality of datasets is generated.

### BACKGROUND

The present invention relates to data pipelines, and more specifically, to modifying data pipelines and dataset quality using real-time dataset classification and data observability analysis.

A data pipeline is a method/architecture in which raw data is ingested from various data sources and then ported to data store, such as a data lake or data warehouse, for analysis. The data is oftentimes transformed prior to being stored. Data pipelines can act as the “piping” for data science projects or business intelligence dashboards. Well-organized data pipelines provide the foundation for a range of data projects; this can include exploratory data analyses, data visualizations, and machine learning tasks.

One example of the use of a data pipeline is an exploratory data analysis (EDA), which is used by data scientists to analyze and investigate data sets and summarize their main characteristics, often employing data visualization methods. It is oftentimes helpful to determine how best to manipulate data sources to get needed answers, making it easier for data scientists to discover patterns, spot anomalies, test a hypothesis, or check assumptions. Another example of the use of a data pipeline is data visualizations, which represent data via common graphics, such as charts, plots, infographics, and even animations. These visual displays of information can communicate complex data relationships and data-driven insights in an easily-understandable manner. Yet another example of use of a data pipeline is machine learning (ML). Machine learning is a branch of artificial intelligence (AI) and computer science which focuses on the use of data and algorithms to imitate the way that humans learn, gradually improving its accuracy. Through the use of statistical methods, algorithms are trained to make classifications or predictions, uncovering key insights within data mining projects.

The data (e.g., datasets) within the data sources used by a data pipeline can vary in terms of quality and usage. Generally, it is desirable to have high-quality data be used more frequently and low-quality data be used less frequently. High-quality data is usually more costly to maintain, and consequently, the use of high-quality data should be encouraged to justify the upkeep costs of the data. Consequently, there is a need to analyze data pipelines in a computer architecture (also referred to herein as data/AI platform) and recommend/implement actions for enhancing data utilization and cost efficiency trade-offs of the datasets within the data/AI platform.

### SUMMARY

A computer-implemented process for modifying one or more of a plurality of data pipelines within a computer architecture that process data from a plurality of datasets includes the following operations. Real-time observability data regarding the plurality of data pipelines and the plurality of datasets is ingested. A dataset from the plurality of datasets is classified based upon usage and reliability to generate a classification of the dataset. Based upon the classification, a recommendation to modify at least one of the plurality of data pipelines is generated. The recommendation is a computer data structure that causes one or more changes/modifications to the data/AI platform.

In other aspects of the process, if the dataset is classified as low usage and low reliability, the recommendation includes replacing, for at least one of the plurality of data pipelines, the dataset with a higher-quality dataset. Alternatively, if the dataset is classified as low usage and low reliability, the recommendation includes moving a portion of the dataset into a lower cost data repository. If the dataset is classified as low usage and high reliability, the recommendation includes modifying the at least one of the plurality of data pipelines to increase usage of the dataset. Alternatively, if the dataset is classified as low usage and high reliability, the recommendation includes reducing data quality actions on the dataset. If the dataset is classified as high usage and high reliability and a determination is made that usage of the dataset is decreasing, the recommendation includes increasing usage of the dataset.

A computer hardware system for modifying one or more of a plurality of data pipelines within a computer architecture that process data from a plurality of datasets includes a hardware processor configured to perform the following executable operations. Real-time observability data regarding the plurality of data pipelines and the plurality of datasets is ingested. A dataset from the plurality of datasets is classified based upon usage and reliability to generate a classification of the dataset. Based upon the classification, a recommendation to modify at least one of the plurality of data pipelines is generated. The recommendation is a computer data structure that causes one or more changes/modifications to the data/AI platform.

In other aspects of the system, if the dataset is classified as low usage and low reliability, the recommendation includes replacing, for at least one of the plurality of data pipelines, the dataset with a higher-quality dataset. Alternatively, if the dataset is classified as low usage and low reliability, the recommendation includes moving a portion of the dataset into a lower cost data repository. If the dataset is classified as low usage and high reliability, the recommendation includes modifying the at least one of the plurality of data pipelines to increase usage of the dataset. Alternatively, if the dataset is classified as low usage and high reliability, the recommendation includes reducing data quality actions on the dataset. If the dataset is classified as high usage and high reliability and a determination is made that usage of the dataset is decreasing, the recommendation includes increasing usage of the dataset.

A computer program product includes a computer readable storage medium having stored therein program code for modifying one or more of a plurality of data pipelines within a computer architecture that process data from a plurality of datasets. The program code, which when executed by a computer hardware system, cause the computer hardware system to perform the following. Real-time observability data regarding the plurality of data pipelines and the plurality of datasets is ingested. A dataset from the plurality of datasets is classified based upon usage and reliability to generate a classification of the dataset. Based upon the classification, a recommendation to modify at least one of the plurality of data pipelines is generated. The recommendation is a computer data structure that causes one or more changes/modifications to the data/AI platform.

In other aspects of the computer program product, if the dataset is classified as low usage and low reliability, the recommendation includes replacing, for at least one of the plurality of data pipelines, the dataset with a higher-quality dataset. Alternatively, if the dataset is classified as low usage and low reliability, the recommendation includes moving a portion of the dataset into a lower cost data repository. If the dataset is classified as low usage and high reliability, the recommendation includes modifying the at least one of the plurality of data pipelines to increase usage of the dataset. Alternatively, if the dataset is classified as low usage and high reliability, the recommendation includes reducing data quality actions on the dataset. If the dataset is classified as high usage and high reliability and a determination is made that usage of the dataset is decreasing, the recommendation includes increasing usage of the dataset.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1A is a block diagram of a data/AI platform according to an aspect of the present invention.

FIG. 1B is a block diagram further illustrating the architecture of a data observability platform according to an aspect of the present invention.

FIG. 2 illustrates a methodology of employing the data observability platform of FIG. 1B according to an aspect of the present invention.

FIG. 3 illustrates a methodology of generating a recommendation upon classifying a dataset as high usage and high reliability according to an aspect of the present invention.

FIG. 4 illustrates a methodology of generating a recommendation to increase usage upon classifying a dataset as low usage and high reliability according to an aspect of the present invention.

FIG. 5 illustrates a methodology of generating a recommendation to reduce data quality efforts upon classifying a dataset as low usage and high reliability according to an aspect of the present invention.

FIG. 6 illustrates a methodology of generating a recommendation upon classifying a dataset as low usage and low reliability according to an aspect of the present invention.

FIG. 7 is a block diagram illustrating an example of computer hardware system for implementing the deep context disambiguation system of FIG. 1.

### DETAILED DESCRIPTION

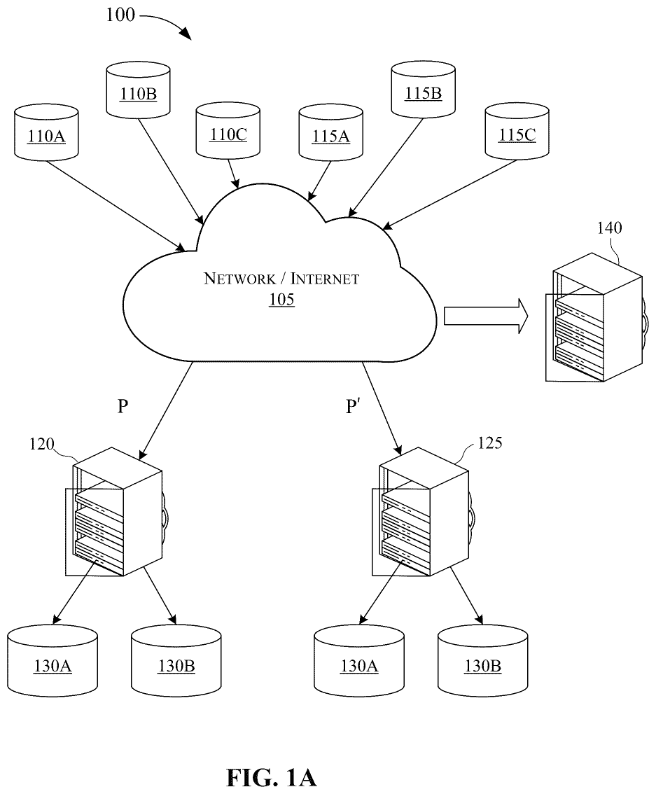

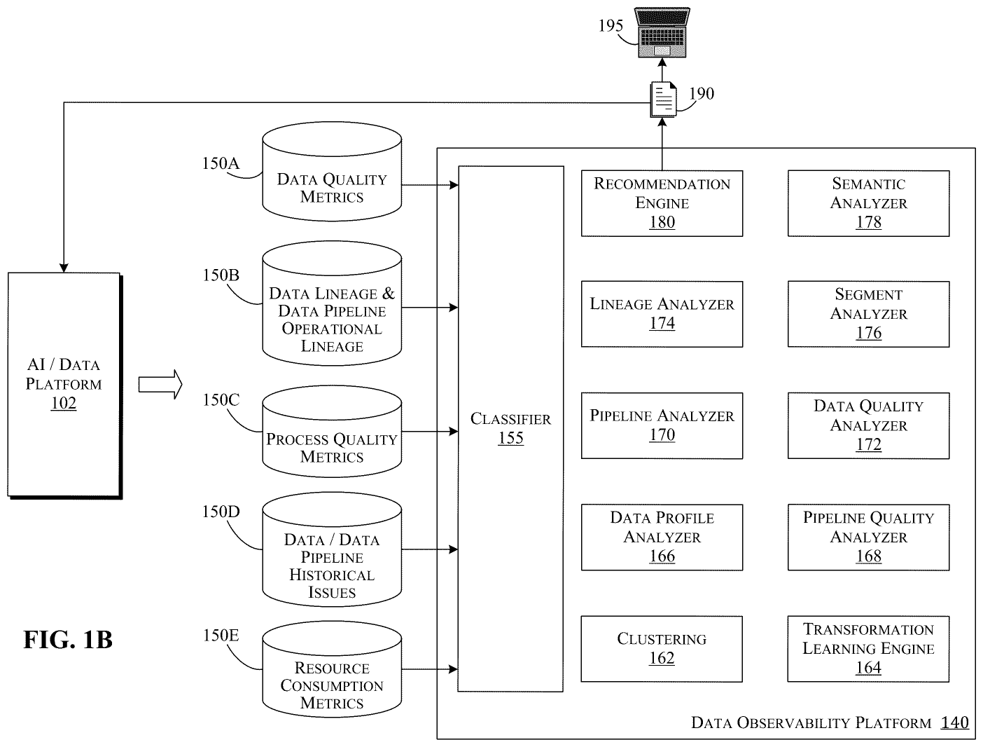

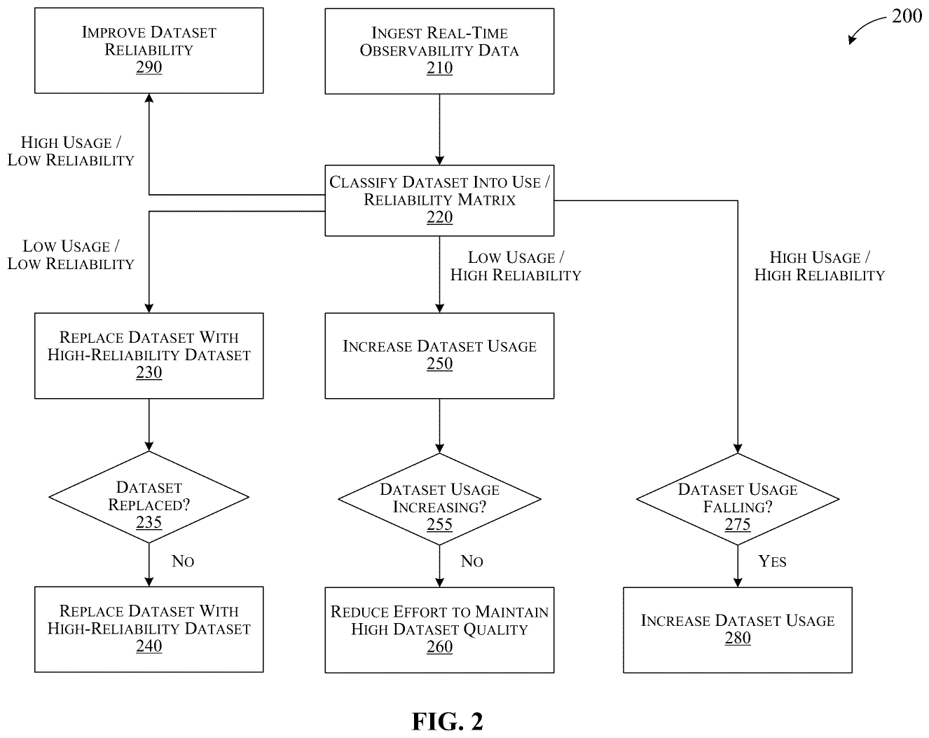

Reference is made to FIGS. 1A-1B and 2, which respectively illustrate an architecture 100 and methodology 200 and for enhancing data utilization of a data/AI platform 102 within the architecture 100 using a data observability platform 140. More specifically, a computer-implemented process 200 for modifying one or more of a plurality of data pipelines P, P′ within a computer architecture 100 that process data from a plurality of datasets 110A-C, 115A-C includes the following operations. Real-time observability data 150A-E regarding the plurality of data pipelines P, P′ and the plurality of datasets 110A-C, 115A-C is ingested. A dataset 110A from the plurality of datasets 110A-C, 115A-C is classified based upon usage and reliability to generate a classification of the dataset 110A. Based upon the classification, a recommendation 190 to modify at least one of the plurality of data pipelines P, P′ is generated. The recommendation 190 is a computer data structure that causes one or more changes/modifications to a data/AI platform within the computer architecture 100 that improves the functionality/usability of the computer architecture 100.

In other aspects of the process, if the dataset 110A is classified as low usage and low reliability, the recommendation 190 includes replacing, for at least one of the plurality of data pipelines P, P′, the dataset 110A with a higher-quality dataset 110B. Alternatively, if the dataset 110A is classified as low usage and low reliability, the recommendation 190 includes moving a portion of the dataset 110A into a lower cost data repository. If the dataset 110A is classified as low usage and high reliability, the recommendation 190 includes modifying the at least one of the plurality of data pipelines P, P′ to increase usage of the dataset 110A. Alternatively, if the dataset 110A is classified as low usage and high reliability, the recommendation 190 includes reducing data quality actions on the dataset 110A. If the dataset 110A is classified as high usage and high reliability and a determination is made that usage of the dataset 110A is decreasing, the recommendation 190 includes increasing usage of the dataset 110A.

A computer hardware system 140 for modifying one or more of a plurality of data pipelines P, P′ within a computer architecture 100 that process data from a plurality of datasets 110A-C, 115A-C includes a hardware processor configured to perform the following executable operations. Real-time observability data 150A-E regarding the plurality of data pipelines P, P′ and the plurality of datasets 110A-C, 115A-C is ingested. A dataset 110A from the plurality of datasets 110A-C, 115A-C is classified based upon usage and reliability to generate a classification of the dataset 110A. Based upon the classification, a recommendation 190 to modify at least one of the plurality of data pipelines P, P′ is generated. The recommendation 190 is a computer data structure that causes one or more changes/modifications to a data/AI platform within the computer architecture 100 that improves the functionality/usability of the computer architecture 100.

In other aspects of the system, if the dataset 110A is classified as low usage and low reliability, the recommendation 190 includes replacing, for at least one of the plurality of data pipelines P, P′, the dataset 110A with a higher-quality dataset 110B. Alternatively, if the dataset 110A is classified as low usage and low reliability, the recommendation 190 includes moving a portion of the dataset 110A into a lower cost data repository. If the dataset 110A is classified as low usage and high reliability, the recommendation 190 includes modifying the at least one of the plurality of data pipelines P, P′ to increase usage of the dataset 110A. Alternatively, if the dataset 110A is classified as low usage and high reliability, the recommendation 190 includes reducing data quality actions on the dataset 110A. If the dataset 110A is classified as high usage and high reliability and a determination is made that usage of the dataset 110A is decreasing, the recommendation 190 includes increasing usage of the dataset 110A.

A computer program product includes a computer readable storage medium having stored therein program code for modifying one or more of a plurality of data pipelines P, P′ within a computer architecture 100 that process data from a plurality of datasets 110A-C, 115A-C. The program code, which when executed by a computer hardware system 140, cause the computer hardware system 140 to perform the following. Real-time observability data 150A-E regarding the plurality of data pipelines P, P′ and the plurality of datasets 110A-C, 115A-C is ingested. A dataset 110A from the plurality of datasets 110A-C, 115A-C is classified based upon usage and reliability to generate a classification of the dataset 110A. Based upon the classification, a recommendation 190 to modify at least one of the plurality of data pipelines P, P′ is generated. The recommendation 190 is a computer data structure that causes one or more changes/modifications to a data/AI platform within the computer architecture 100 that improves the functionality/usability of the computer architecture 100.

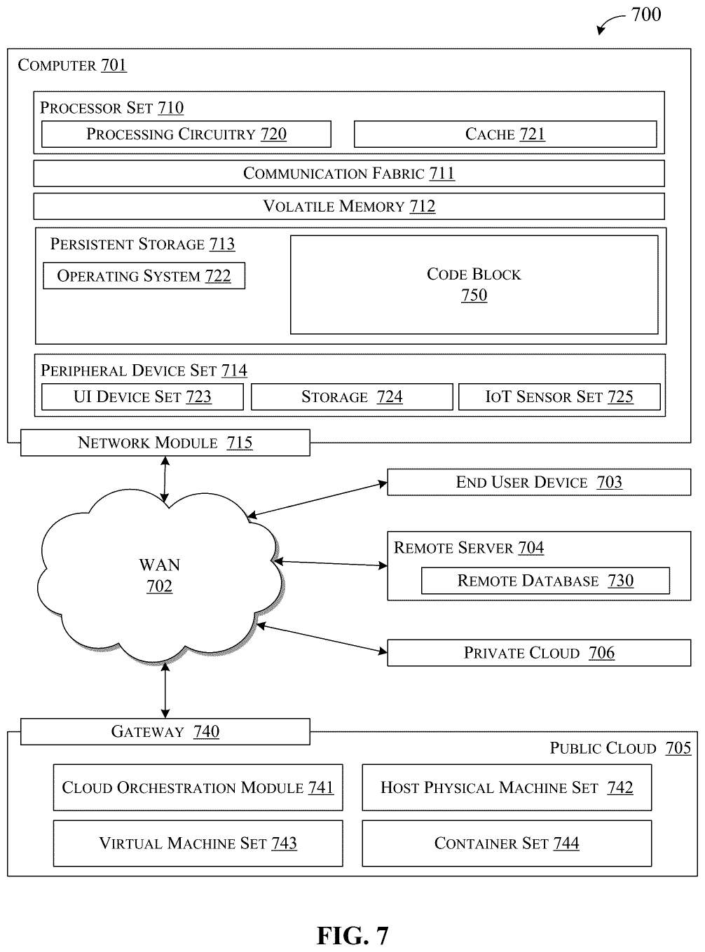

In other aspects of the computer program product, if the dataset 110A is classified as low usage and low reliability, the recommendation 190 includes replacing, for at least one of the plurality of data pipelines P, P′, the dataset 110A with a higher-quality dataset 110B. Alternatively, if the dataset 110A is classified as low usage and low reliability, the recommendation 190 includes moving a portion of the dataset 110A into a lower cost data repository. If the dataset 110A is classified as low usage and high reliability, the recommendation 190 includes modifying the at least one of the plurality of data pipelines P, P′ to increase usage of the dataset 110A. Alternatively, if the dataset 110A is classified as low usage and high reliability, the recommendation 190 includes reducing data quality actions on the dataset 110A. If the dataset 110A is classified as high usage and high reliability and a determination is made that usage of the dataset 110A is decreasing, the recommendation 190 includes increasing usage of the dataset 110A. An example of a tool for implementing such a data/AI platform 102 is IBM® DataStage®. Although the data observability platform 140 is illustrated as including storage and functional components 150-180, one or more of these storage and functional components 150-190 may be external to the data observability platform 140. For example, one or more of the observability data storage 150A-E could be located in the cloud, as described in more detail with regard to FIG. 7.

Referring to FIG. 1A, the data observability platform 140 collects real-time observability data 150A-E from one or more data pipelines P, P′. In broad terms, a data pipeline P, P′, is a well-known type of architecture/methodology in which raw data is ingested from one or more data sources 110A-C, 115A-C and ported to one or more data repositories 130A-B, 140A-B. Additionally, prior to the data being stored within the data repositories 130A-B, 140A-B, the data typically undergoes some type of data processing, such as filtering, masking, and aggregation. Additionally, the data repositories 130A-B, 140A-B oftentimes have a defined schema, which can require that new data be aligned, as necessary, with the previously-stored data. As used herein, the term “pipeline” can include the one or more data sources 110A-C, 115A-C and/or the one or more data repositories 130A-B, 140A-B.

The types of data sources 110A-C, 115A-C are not limited and can includes a wide variety of formats such as APIs, SQL and NoSQL databases, files, et cetera. The data can include various data structures (e.g., structured and unstructured data). The data from these data sources 110A-C, 115A-C is typically ingested (i.e., received) by one or more server systems 120, 125 configured to do so. Once received, the data is processed/transformed into a format needed for the destination data repositories 130A-B, 140A-B. This can also be performed by the one or more server systems 120, 125. For example, a data stream may come in a nested JSON format, and the data transformation stage will aim to unroll that JSON to extract the key fields for analysis. Once transformed, the transformed data is stored within the one or more data repositories 130A-B, 140A-B. This data can then be exposed to various stakeholders.

Referring to FIG. 1B, the data observability platform 140 includes a classifier 155 that classifies datasets in the data sources 110A-C, 115A-C based upon the real-time observability data 150A-E gathered from the one or more data pipelines P, P′. As discussed in greater detail with regard to FIGS. 2-6, the data observability platform 140 employs one or more functional modules 162-180 to generate a recommendation 190 for use with the data/AI platform. As used herein, a recommendation 190 is a computer data structure that causes one or more changes/modifications to the data/AI platform. The recommendation 190, for example, can be visually outputted to a user 195 or be used to automatically modify the data/AI platform 102.

Referring specifically to FIG. 2, the process 200 of employing the data observability platform 140 involves, in 210, the data observability platform 140 ingesting the real-time observability data 150A-E. Examples of real-time observability data includes data quality (DQ) metrics 150A, data lineage and data pipeline operational lineage 150B, process quality metrics 150C for each of the data pipelines P, P′ (e.g., run-duration, data-volume processed and output), data/data pipeline historical issues 150D such as history of errors encountered on data pipelines P, P′ and history of various data quality issues encountered on the datasets, and resource consumption metrics 150E. The real-time observability data 150A-E is not limited to the types of data discussed above. For example, the real-time observability data 150A-E can also include details of identified root causes of various data pipeline failures among others.

The data observability platform 140 is not limited in the manner in which the real-time observability data 150A-E is collected. For example, individual components of the data/AI platform 102 can be instrumented to generate the metrics found with the real-time observability data 150A-E and push those metrics to the data observability platform 140.

In 220, the classifier 155 is configured to classify the dataset into one of four different classifications: (i) low use/low reliability, (ii) low usage/high reliability, (iii) high usage/high reliability, and (iv) high usage/low reliability. Whether a dataset is classified as high/low reliability and high/low usage can be based upon predetermined standards that may vary depending upon the type of data/AI platform being evaluated. In addition to or alternatively, the standards for determining high/low reliability and high/low usage can be determined using a machine learning engine (not illustrated) with changes in real-time observability data 150A-E resulting from changes to the data/AI platform 102 being used as feedback to the machine learning engine.

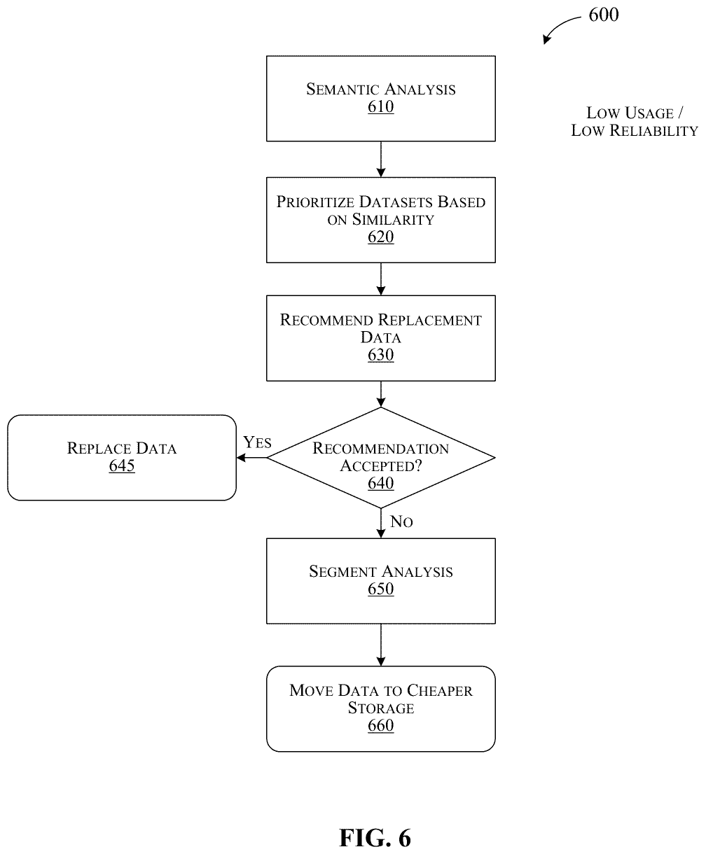

Based upon the classification of the dataset, in 220, the process 200 proceeds down one of four different paths. If the dataset is classified as low usage/low reliability, in 230, a recommendation 190 can be made to replace the prior dataset with a higher-reliability dataset. In addition to or alternatively, if it is determined that the dataset is not replaced, in 235, a recommendation 190 can be made, in 240, to reduce the storage cost of the dataset. This path 600 is discussed in more detail with regard to the FIG. 6.

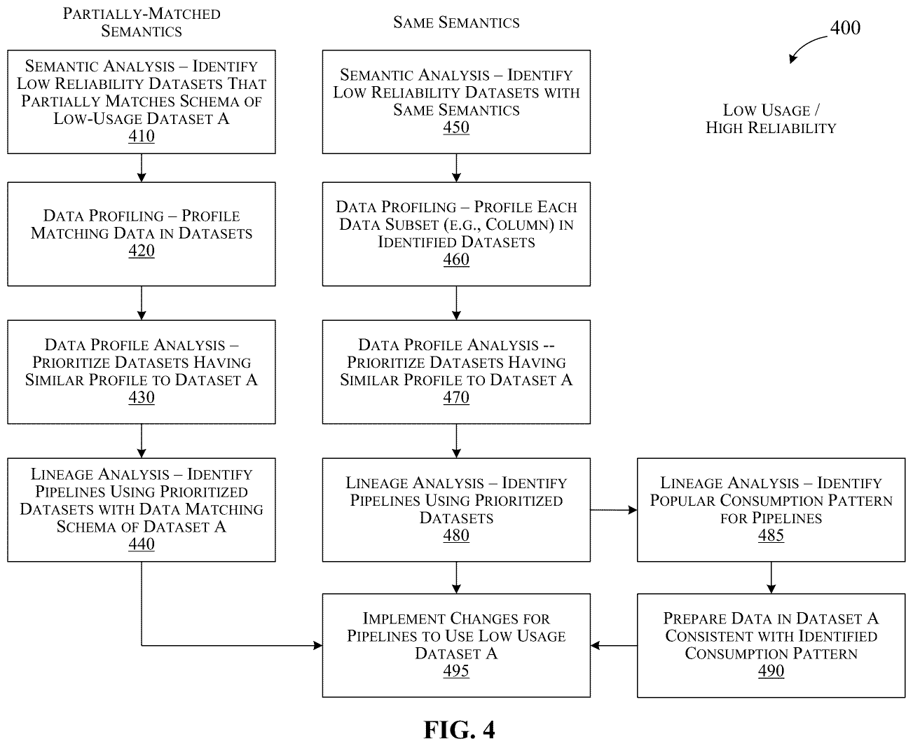

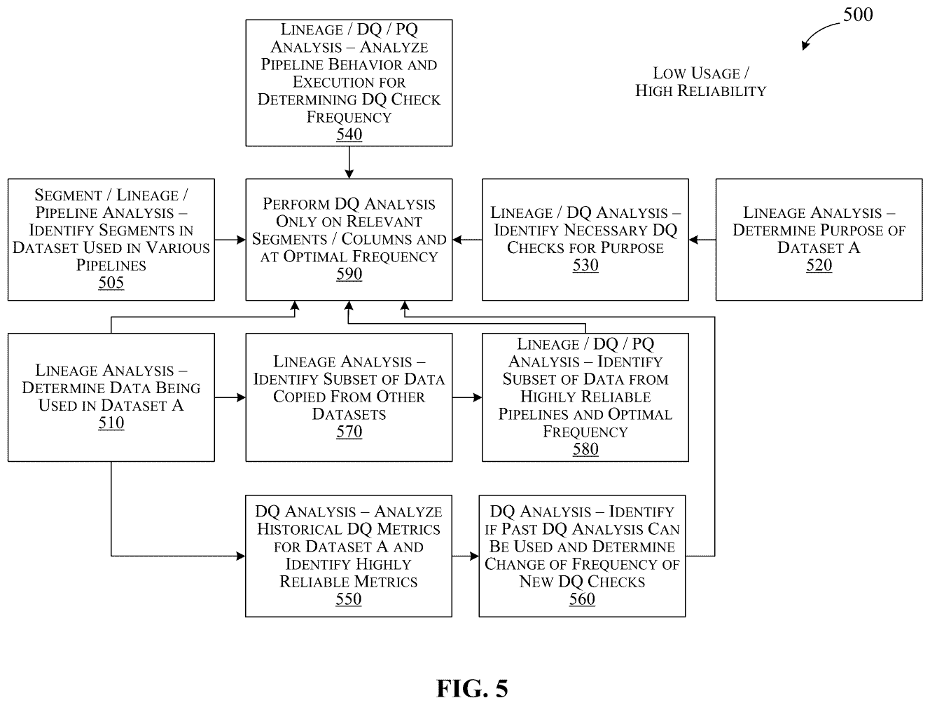

If the dataset is classified as low usage/high reliability, in 250, the recommendation engine 180 can generate a recommendation 190 to increase dataset usage. This path 400 is discussed in more detail with regard to the FIG. 4. In addition to or alternatively, if it is determined that the dataset usage is decreasing or not increasing, in 255, a recommendation 190 can be made, in 260, to reduce efforts to maintain high dataset quality. This path 500 is discussed in more detail with regard to the FIG. 5.

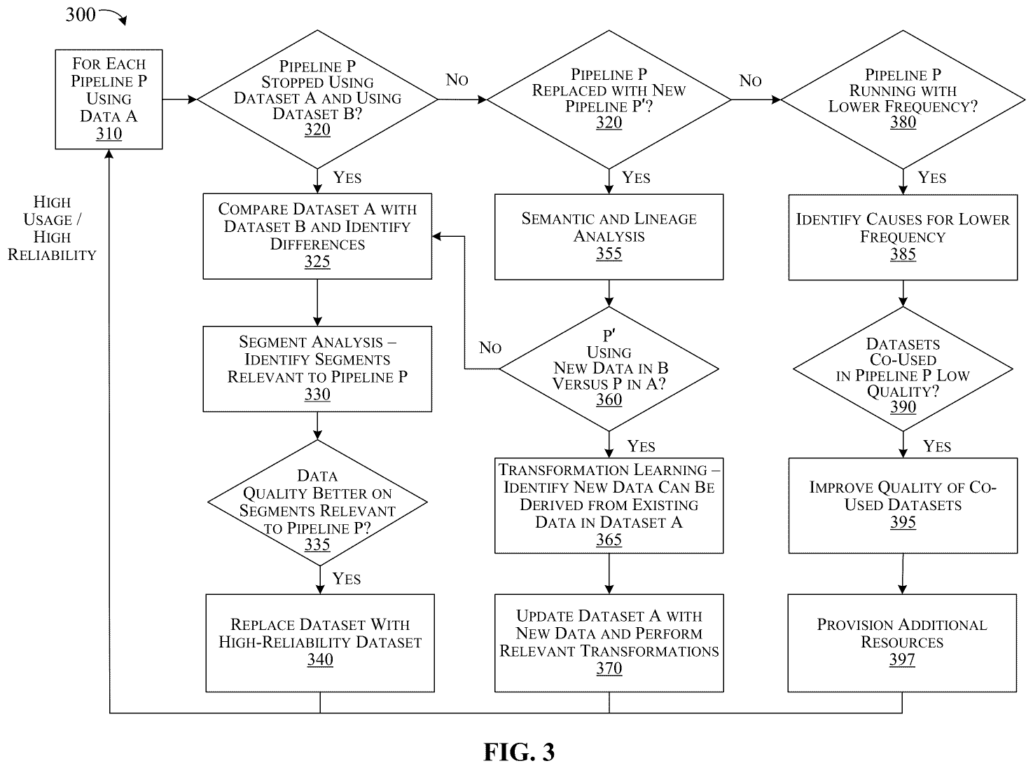

If the dataset is classified as high usage/high reliability, then dataset usage is determined to be optimal. However, in 275, if a determination is made that dataset usage is falling, a recommendation 190 can be made, in 280, to increase dataset usage. This path 300 is discussed in more detail with regard to the FIG. 3.

If the dataset is classified as high usage/low reliability, then the process proceeds to 290 in which a recommendation is made to improve dataset reliability 290. There are many known ways to increase dataset reliability 290 and the process 200 is not limited as to any particular approach for doing so.

Referring to FIG. 3, the illustrated process 300 can be performed when the classifier 155 classifies a dataset as high usage/high reliability. The process 300 begins, in 310, by looking at each data pipeline (e.g., P) using a particular dataset (e.g., 110A) and performing a number of different causal analysis 320, 350, 380 to determine why usage of the particular dataset 110A is dropping. Although illustrated being performed in series, each causal analysis 320, 350, 380 can be performed in parallel or in a different order than depicted.

The causal analysis of 320 includes a determination as to whether the data pipeline P has stopped using dataset 110A and is instead using a new dataset 110B. If so, an assumption can be made that no changes were made to the data pipeline P and that the new dataset 110B has the same schema as (or is a superset of) the prior dataset 110A. Also, in 325, a comparison can be made between the prior dataset 110A and the new dataset 110B to identify the differences there between.

In 330, the segment analyzer 176 is configured to identify segments of the new dataset 110B that are relevant to the data pipeline P. In 335, a determination is made as to whether the data quality on these identified segments of the new dataset 110B, which are relevant to the data pipeline P, are better. If the determination is made that the data quality is better, then remediation methods are applied to those identified segments contained in the prior dataset 110A. For example, the remediation can be to improve quality of the identified segments in the prior dataset 110A. Additionally, this causal analysis 320 can determine whether new data classes exist in the new dataset 110B. If so, the specification of the new data can be specified, and the recommendation engine 180 can generate a recommendation 190 to update the dataset 110B. For example, the recommendation can be to check if the prior dataset 110A can be updated to reflect the new data classes.

The causal analysis of 350 includes a determination as to whether the prior data pipeline P has been replaced with a new data pipeline P′ or the prior data pipeline P has been replaced with a new version of the prior data pipeline P. If so, an assumption can be made that P′ (or the new revision of P) includes a new dataset 115B in which the schema has been changed. Also, in 355, the semantic analyzer 178 and lineage analyzer 174 performs a semantic and lineage analysis to determine if the new data pipeline P′ is using new data (e.g., new columns) in the new dataset 115B that are not found in the dataset 110A used by the prior data pipeline P. If new data is not being used, the causal analysis of 350 proceeds to 325.

If new data is being used in the new dataset 115, in 365, a transformation learning engine 365 (e.g., a type of machine learning engine), is configured to determine if the new data in the new dataset 115B can be derived from existing data in the dataset 110A in the prior pipeline P. In 370, the recommendation engine 180 generates a recommendation to update the old dataset 110A to include the new data and/or update the prior data pipeline P to perform a transformation on the existing data in the dataset 110A to the extent that the new data can be derived from existing data in the dataset 110A.

The causal analysis of 380 includes a determination as to whether the data pipeline P is operating at a lower frequency. If so, in 385, potential causes for the lower frequency are identified, and the recommendation engine 180 can generate a recommendation 190 to remediate those causes. Also, in 390, a determination can be made whether any of the other datasets 110A-C used by the data pipeline P are classified as low quality. If so, in 395, the recommendation engine 180 can generate a recommendation 190 to improve the quality of the datasets 110A-C determined to be low quality.

Referring to FIG. 4, the illustrated process 400 can be performed upon the classifier 155 classifying a dataset 110A as low usage/high reliability and an intent is to increase usage of the dataset 110A. The process 300 can go down two paths. In 410, 450, a semantic analysis is performed by the semantic analyzer 176 on the dataset 110A to identify low reliability (either high or low usage) dataset(s) that have the same semantics as the initial dataset 110A or having a subset of data (e.g., columns) that matches the schema of the initial dataset 110A. If the dataset 110A cannot be analyzed by the semantic analyzer 160 (i.e., the dataset 110A is not discoverable), various semantic metadata can be added to the dataset 110A. For example, business terms can be added at a column level and/or at an asset level. Additionally, tags can be added to the data and natural language expansion can be performed on the columns.

If the low reliability dataset(s) has the same semantics, the process 400 continues from 450. In 460, the data profile analyzer 166, profiles each data subset (e.g., columns) in the identified low reliability dataset(s), and in 470, the data profile analyzer 166 prioritizes the identified low reliability dataset(s) based upon the similarity to the initial dataset 110A. Next, in 480, the lineage analyzer 174 performs an analysis that identifies pipelines P′ that use the identified low reliability dataset(s). In 495, the recommendation engine 180 generates a recommendation 190 for the identified pipelines P′ to use the low usage/high reliability dataset.

In 485, the lineage analyzer 174 can perform an additional analysis whereby similar datasets with high usage are identified. Once identified these similar datasets with high usage are analyzed to determine how the data contained therein is consumed. From this analysis, popular (i.e., high usage) consumption patterns are determined. In 490, the recommendation engine 180 generates a recommendation 190 to modify the initial dataset 110A in a manner (e.g., change the schema—for example, instead of an address, the schema may require that the street name, city, and zip code be divided out) such that the initial dataset 110A is more attractive to be used according to these identified popular consumption patterns.

Alternative, if in 410, a determination is made that the low reliability dataset(s) have certain subsets (e.g., columns) of data that matches the schema of the initial dataset 110, the process proceeds to 420. Operations 420, 430, 440 are similar to operations 460, 470, 480 except the analysis is only performed on those subsets of the of the low reliability datasets(s) that match the schema of the initial dataset 110.

Referring to FIG. 5, the illustrated process 500 can be performed when the classifier 155 classifies a dataset 110A as low usage/high reliability and an intent is to reduce the effort (cost) of maintain the data quality of the dataset 110A. There are a number of different paths that can be taken depending upon an initial assumption regarding the dataset 110. For example, if a determination is made that only some segments in the dataset 110A are being used, the process proceeds to 505, in which the segment analyzer 176 identifies those segments in the dataset 110A being used, the lineage analyzer 174 and the pipeline analyzer 170 determines what pipelines P, P′ are using the segments in the dataset 110A. Based upon this analysis, in 590, the recommendation engine 180 can generate a recommendation 190 that data quality checks be performed (and at what frequency) only for those segments in the dataset 110A that are being used.

For example, a dataset 110A that includes address and various cities (e.g., San Jose, Dallas, Austin), but the pipelines P, P′ only use San Jose and Dallas. In this instance data quality need not be maintained for segments of data not belonging to the San Jose and Dallas locations.

As another example, a determination can be made that only certain subsets (e.g., columns) of the dataset 110A are being used. In this instance, the process begins at 500, in which lineage analyzer 174 determines what subsets of the dataset 110A are being used. Based upon this analysis, in 590, the recommendation engine 180 can generate a recommendation that data quality actions (e.g., checks) be performed (and at what frequency) only for those subsets in the dataset 110A that are being used.

In 520, the lineage analyzer 174 can perform a lineage analysis on the dataset 110A to determine for what purpose the dataset 110A is being used. Next, in 530, the lineage analyzer 174 can interact with the data quality analyzer 172 to determine what subset of data quality operations are relevant to the purpose identified in 520. Based upon this analysis, in 590, the recommendation engine 180 can generate a recommendation 190 what data quality checks should be performed (and at what frequency) that are relevant to the purpose.

In 540, the lineage analyzer 174, the data quality analyzer 172, and the pipeline quality analyzer 168 can operate together to determine pipeline behavior to support the recommendation engine 180 making a recommendation 190 based upon that analysis. For example, assume the pipelines P, P′ run at 12 AM daily and the pipelines P, P′ use the past 6 hours and it is determine that data batches arrive every 30 minutes. In this instance, the recommendation engine 180 can make a recommendation that data quality need only be maintained for the 6 hour period the precedes the checking of data at 12 AM. In this instance, the recommendation 190 is to maintain the data that arrives between 6 PM and 12 AM daily and there is no need to maintain the data during other time periods.

Using the data from 510, in which segments being used in the dataset 110A are identified, in 550, the data quality analyzer 172 can determine what historical data quality metrics for the dataset 110A are highly-reliable. If the data quality metrics are highly-reliable, then the frequency of those checks can be reduced in 560 using the data quality analyzer 172. For example, if a first reading of the data quality metric is 100% (with a threshold of 90% required by the pipelines P, P′) and second reading of the data quality metric is 97%, then the frequency in which the data quality of the dataset 110A is checked can be reduced. However, if a subsequent data check reveals that the required threshold has not been reached, the frequency of in which the data quality of the data 110A is checked can be increased. As another example, if ten consecutive data batches have 100% accuracy and a 90% threshold is needed, an assumption can be made that even if the 11th batch is completely in error, then the 90% threshold will still be reached. Consequently, a data check need not be performed on the 11th batch. Based upon this analysis, in 590, the recommendation engine 180 can generate a recommendation 190 that the frequency in which data quality checks are performed be changed.

Alternatively, using the data from 510, in which segments being used in the dataset 110A are identified, in 570, the lineage analyzer 174 can determine if any subsets (e.g., columns) of data 110A have been copied from other datasets 110B, 110C. In 540, the lineage analyzer 174, the data quality analyzer 172, and the pipeline quality analyzer 168 can operate together to determine which of those previously-identified subset of data from 570 are from highly-reliable datasets 110B, 110C. For those subsets of data from highly-reliable datasets 110B, 110C, the data quality metrics associated with those highly-reliable datasets 110B, 110C can be used as data quality metrics for the initial dataset 110A. Based upon this analysis, in 590, the recommendation engine 180 can generate a recommendation 190 that changes the frequency in which data quality checks are performed on the initial dataset 110A to reflect that the dataset 110A contains data from already highly-reliable datasets 110B, 110C.

Referring to FIG. 6, the illustrated process 600 can be performed when the classifier 155 classifies a particular dataset as low usage/low reliability. Based upon this classification, the data observability platform is configured to replace the particular dataset with a higher reliability data and/or move the particular dataset into cheaper storage. The process 600 begins, in 610, with the semantic analyzer 178 performing a semantic analysis on the particular dataset (e.g., 110A) determined to be low reliability. A semantic analysis is also performed on different datasets (e.g., 110B, 110C) determined to be of higher reliability.

In 620, based upon the semantic analysis, the other datasets 110B, 110C are compared to the initial dataset 110A and those datasets 110B, 110C that are more similar to the initial dataset 110A are prioritized. In 630, based upon prioritization of the other datasets 110B, 110C, the recommendation engine 180 generates a recommendation 190 to replace the initial dataset 110A with one of the other datasets 110B, 110C. The prioritization of the other datasets 110B, 110C is not limited as to a particular approach. However, one approach for prioritizing the other datasets can include identifying those datasets 110B, 110C that are being co-used in the pipeline P. Another approach to prioritizing the other datasets can include identifying datasets 115A-C in an important pipeline P′ in which the quality of the datasets 115A-C used therein are anticipated to be maintained at a high level.

In 645, if the recommendation 190 is determined to be accepted in 640, the initial dataset 110A is replaced with one of the other datasets 110B, 110C. In 580, the lineage analyzer 174, the data quality analyzer 172, and the pipeline quality analyzer 168 can operate together can operation together to determine pipeline behavior to support the recommendation engine 180 making a recommendation 190 based upon that analysis.

In 650, the process 600 can also include the segment analyzer 176 performing an analysis on the initial dataset 110A to determine what segments of the initial dataset 110 are being used. Since the initial dataset 110A was classified as low usage, an assumption can be made that those segments of the initial dataset—other than those segments being used—are unlikely to be used. In 660, the recommendation engine 180 generates a recommendation 190 to move those segments that are determined to be unlikely to be used into a less expensive data repositories (e.g., data repository 130B may be less expensive than data repository 130A).

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 7, computing environment 700 contains an example of an environment for the execution of at least some of the computer code involved in performing the inventive methods, such as code block 750 for implementing the operations of the data observability platform 140. Computing environment 700 includes, for example, computer 701, wide area network (WAN) 702, end user device (EUD) 703, remote server 704, public cloud 705, and private cloud 706. In certain aspects, computer 701 includes processor set 710 (including processing circuitry 720 and cache 721), communication fabric 711, volatile memory 712, persistent storage 713 (including operating system 722 and method code block 750), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. However, to simplify this presentation of computing environment 700, detailed discussion is focused on a single computer, specifically computer 701. Computer 701 may or may not be located in a cloud, even though it is not shown in a cloud in FIG. 7 except to any extent as may be affirmatively indicated.

Processor set 710 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In certain computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in code block 750 in persistent storage 713.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 711 is the signal conduction paths that allow the various components of computer 701 to communicate with each other. Typically, this communication fabric 711 is made of switches and electrically conductive paths, such as the switches and electrically conductive paths that make up busses, bridges, physical input/output ports and the like. Other types of signal communication paths may be used for the communication fabric 711, such as fiber optic communication paths and/or wireless communication paths.

Volatile memory 712 is any type of volatile memory now known or to be developed in the future. Examples include dynamic type random access memory (RAM) or static type RAM. Typically, the volatile memory 712 is characterized by random access, but this is not required unless affirmatively indicated. In computer 701, the volatile memory 712 is located in a single package and is internal to computer 701. In addition to alternatively, the volatile memory 712 may be distributed over multiple packages and/or located externally with respect to computer 701.

Persistent storage 713 is any form of non-volatile storage for computers that is now known or to be developed in the future. The non-volatility of the persistent storage 713 means that the stored data is maintained regardless of whether power is being supplied to computer 701 and/or directly to persistent storage 713. Persistent storage 713 may be a read only memory (ROM), but typically at least a portion of the persistent storage 713 allows writing of data, deletion of data and re-writing of data. Some familiar forms of persistent storage 713 include magnetic disks and solid state storage devices. Operating system 722 may take several forms, such as various known proprietary operating systems or open source Portable Operating System Interface type operating systems that employ a kernel. The code included in code block 750 typically includes at least some of the computer code involved in performing the inventive methods.

Peripheral device set 714 includes the set of peripheral devices for computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some aspects, storage 724 may take the form of a quantum computing storage device for storing data in the form of qubits. In aspects where computer 701 is required to have a large amount of storage (for example, where computer 701 locally stores and manages a large database) then this storage 724 may be provided by peripheral storage devices designed for storing very large amounts of data, such as a storage area network (SAN) that is shared by multiple, geographically distributed computers. Internet-of-Things (IoT) sensor set 725 is made up of sensors that can be used in IoT applications. For example, one sensor may be a thermometer and another sensor may be a motion detector.

Network module 715 is the collection of computer software, hardware, and firmware that allows computer 701 to communicate with other computers through a Wide Area Network (WAN) 702. Network module 715 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 715 are performed on the same physical hardware device. In other aspects (for example, aspects that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any Wide Area Network (for example, the internet) capable of communicating computer data over non-local distances by any technology for communicating computer data, now known or to be developed in the future. In some aspects, the WAN 702 may be replaced and/or supplemented by local area networks (LANs) designed to communicate data between devices located in a local area, such as a Wi-Fi network. The WAN 702 and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In certain aspects, EUD 703 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704. As defined herein, the term “server” means a data processing system configured to share services with one or more other data processing systems.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705.

The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other aspects, a private cloud 706 may be disconnected from the internet entirely (e.g., WAN 702) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 705 and private cloud 706 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method for modifying one or more of a plurality of data pipelines within a computer architecture that process data from a plurality of datasets, comprising:
ingesting real-time observability data regarding the plurality of data pipelines and the plurality of datasets;
classifying a dataset from the plurality of datasets based upon usage and reliability to generate a classification of the dataset; and
generating, based upon the classification, a recommendation to modify at least one of the plurality of data pipelines.

2. The method of claim 1, wherein
the dataset is classified as low usage and low reliability, and
the recommendation includes replacing, for at least one of the plurality of data pipelines, the dataset with a higher-quality dataset.

3. The method of claim 1, wherein
the dataset is classified as low usage and low reliability, and
the recommendation includes moving a portion of the dataset into a lower cost data repository.

4. The method of claim 1, wherein
the dataset is classified as low usage and high reliability, and
the recommendation includes modifying the at least one of the plurality of data pipelines to increase usage of the dataset.

5. The method of claim 1, wherein
the dataset is classified as low usage and high reliability, and
the recommendation includes reducing data quality actions on the dataset.

6. The method of claim 1, wherein
the dataset is classified as high usage and high reliability,
a determination is made that usage of the dataset is decreasing,
the recommendation includes increasing usage of the dataset.

7. The method of claim 1, wherein
the recommendation is a computer data structure that causes one or more changes/modifications to a data/AI platform within the computer architecture.

8. A computer hardware system for modifying one or more of a plurality of data pipelines within a computer architecture that process data from a plurality of datasets, comprising:
a hardware processor configured to perform the following executable operations:
ingesting real-time observability data regarding the plurality of data pipelines and the plurality of datasets;
classifying a dataset from the plurality of datasets based upon usage and reliability to generate a classification of the dataset; and
generating, based upon the classification, a recommendation to modify at least one of the plurality of data pipelines.

9. The system of claim 8, wherein
the dataset is classified as low usage and low reliability, and
the recommendation includes replacing, for at least one of the plurality of data pipelines, the dataset with a higher-quality dataset.

10. The system of claim 8, wherein
the dataset is classified as low usage and low reliability, and
the recommendation includes moving a portion of the dataset into a lower cost data repository.

11. The system of claim 8, wherein
the dataset is classified as low usage and high reliability, and
the recommendation includes modifying the at least one of the plurality of data pipelines to increase usage of the dataset.

12. The system of claim 8, wherein
the dataset is classified as low usage and high reliability, and
the recommendation includes reducing data quality actions on the dataset.

13. The system of claim 8, wherein
the dataset is classified as high usage and high reliability,
a determination is made that usage of the dataset is decreasing,
the recommendation includes increasing usage of the dataset.

14. The system of claim 8, wherein
the recommendation is a computer data structure that causes one or more changes/modifications to a data/AI platform within the computer architecture.

15. A computer program product, comprising:
a computer readable storage medium having stored therein program code for modifying one or more of a plurality of data pipelines within a computer architecture that process data from a plurality of datasets,
the program code, which when executed by a computer hardware system, causes the computer hardware system to perform:
ingesting real-time observability data regarding the plurality of data pipelines and the plurality of datasets;
classifying a dataset from the plurality of datasets based upon usage and reliability to generate a classification of the dataset; and
generating, based upon the classification, a recommendation to modify at least one of the plurality of data pipelines, wherein
the recommendation is a computer data structure that causes one or more changes/modifications to the data/AI platform.

16. The computer program product of claim 15, wherein
the dataset is classified as low usage and low reliability, and
the recommendation includes replacing, for at least one of the plurality of data pipelines, the dataset with a higher-quality dataset.

17. The computer program product of claim 15, wherein
the dataset is classified as low usage and low reliability, and
the recommendation includes moving a portion of the dataset into a lower cost data repository.

18. The computer program product of claim 15, wherein
the dataset is classified as low usage and high reliability, and
the recommendation includes modifying the at least one of the plurality of data pipelines to increase usage of the dataset.

19. The computer program product of claim 15, wherein
the dataset is classified as low usage and high reliability, and
the recommendation includes reducing data quality actions on the dataset.

20. The computer program product of claim 15, wherein
the dataset is classified as high usage and high reliability,
a determination is made that usage of the dataset is decreasing,
the recommendation includes increasing usage of the dataset.
